(19) United States
(12) Patent Application Publication
(10) Pub. No.: US 2009/0056506 A1
(43) Pub. Date: Mar. 5, 2009

(54) Kwik E Wrench

(76) Inventor: Roger Wroy Jordan, (US)

Correspondence Address: ROGER WROY JORDAN, 41814 NO. ROLLING GREEN WAY, ANTHEM, AZ, 85086, US

(21) Appl. No.: 11/899,011

(22) Filed: Sep. 4, 2007

(51) Int. Cl. B25B 13/46

(52) U.S. Cl. 81/60

(57) ABSTRACT

Kwik E wrench is a design of a geared socket with a drive gear housed in container that is nearly the same size as a wrench of like size. Kwik E can be driven by a thumb wheel, another wrench, or an insert for a power driver, drill, electric screwdriver etc. Kwik E wrenches can work in areas that any normal wrench can work.

### CROSS-REFERENCE TO RELATED APPLICATIONS

Not Applicable

### STATEMENT REGARDING FEDERALLY SPONSORED RESEARCH AND DEVELOPMENT

This invention has not been sponsored or associated with any Federally sponsored research and development program.

### REFERENCE TO SEQUENCE LISTING, A TABLE, OR A COMPUTER PROGRAM LISTING COMPACT DISK APPENDIX

Not Applicable

### BACKGROUND OF INVENTION

To quickly remove or tighten fasteners in a confined area. Kwik E Wrench(s) are designed for use in any industry that uses normal hand tools, ie wrenches. The primary design concept of Kwik E Wrench is its unique gear drive that allows for tightening/removing of fasteners/nuts from rods/bolts. With this design, Kwik E Wrench(s) can be used in a confined area where normal wrenches have difficulty of movement.

### BRIEF SUMMARY OF THE INVENTION

The primary design concept of Kwik E Wrench is its unique gear drive that allows for quickly tightening/removing of fasteners/nuts from rods/bolts. Its design is to allow for tightening/removing of fasteners quickly and easily where a normal wrench is confined to limited movement.

### BRIEF DESCRIPTION OF TH SEVERAL VIEWS OF THE DRAWING

FIG. 1 is an assembled view of a ¾ inch Kwik E wrench.

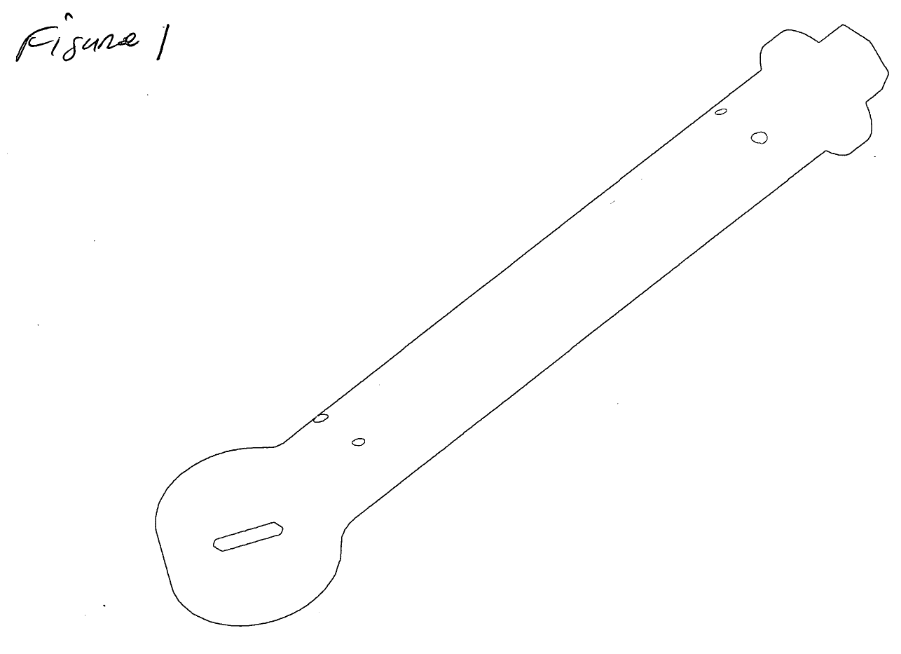

FIG. 2 is an unassembled view of the same wrench.

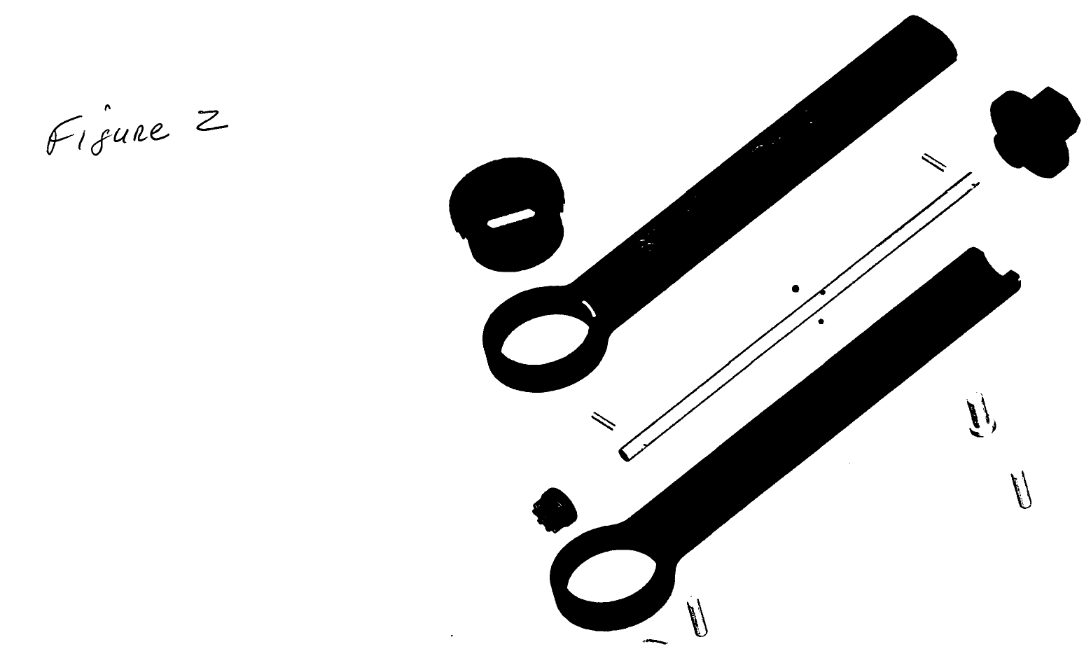

FIG. 3 is an engineered drawing of the dimensions of each component.

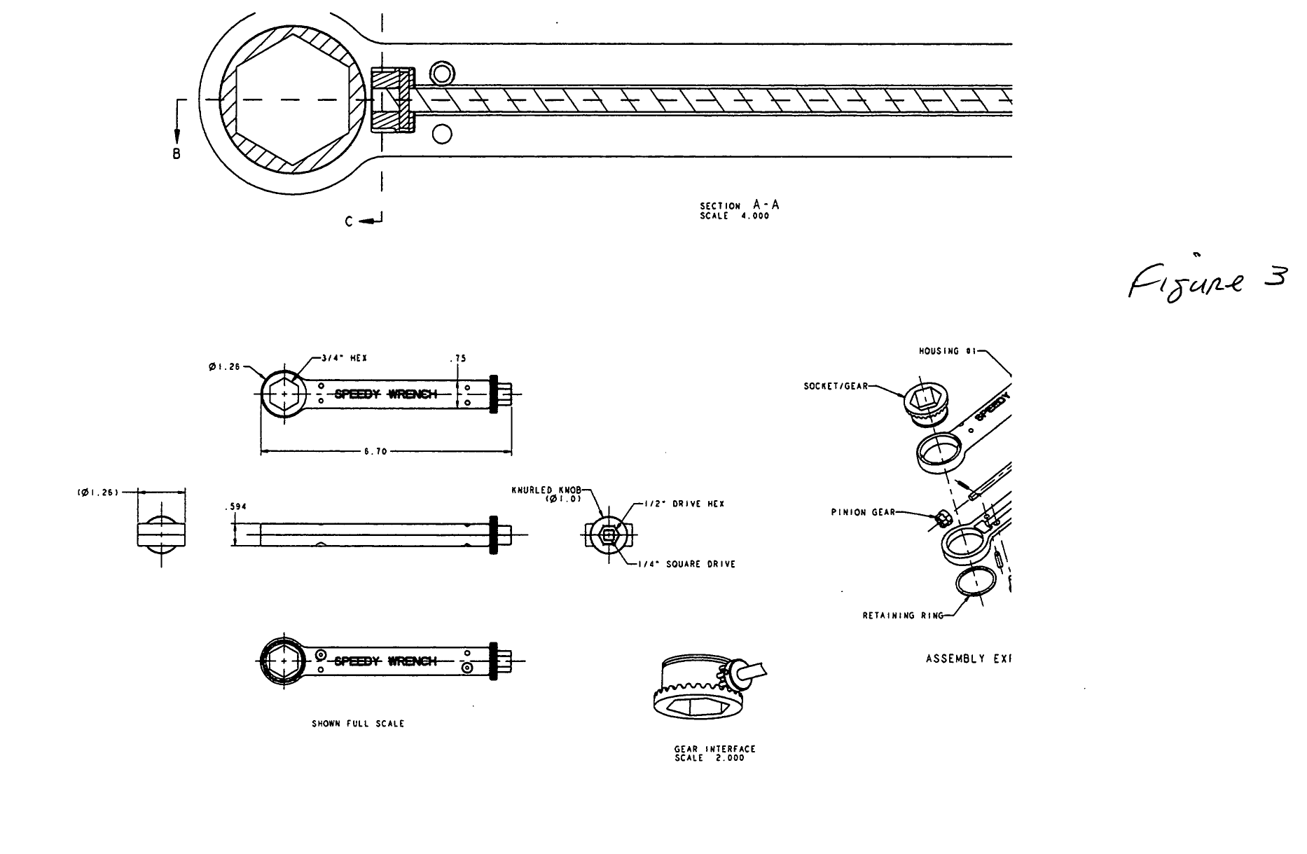

FIG. 3a is an engineered drawing of the dimensions of each component.

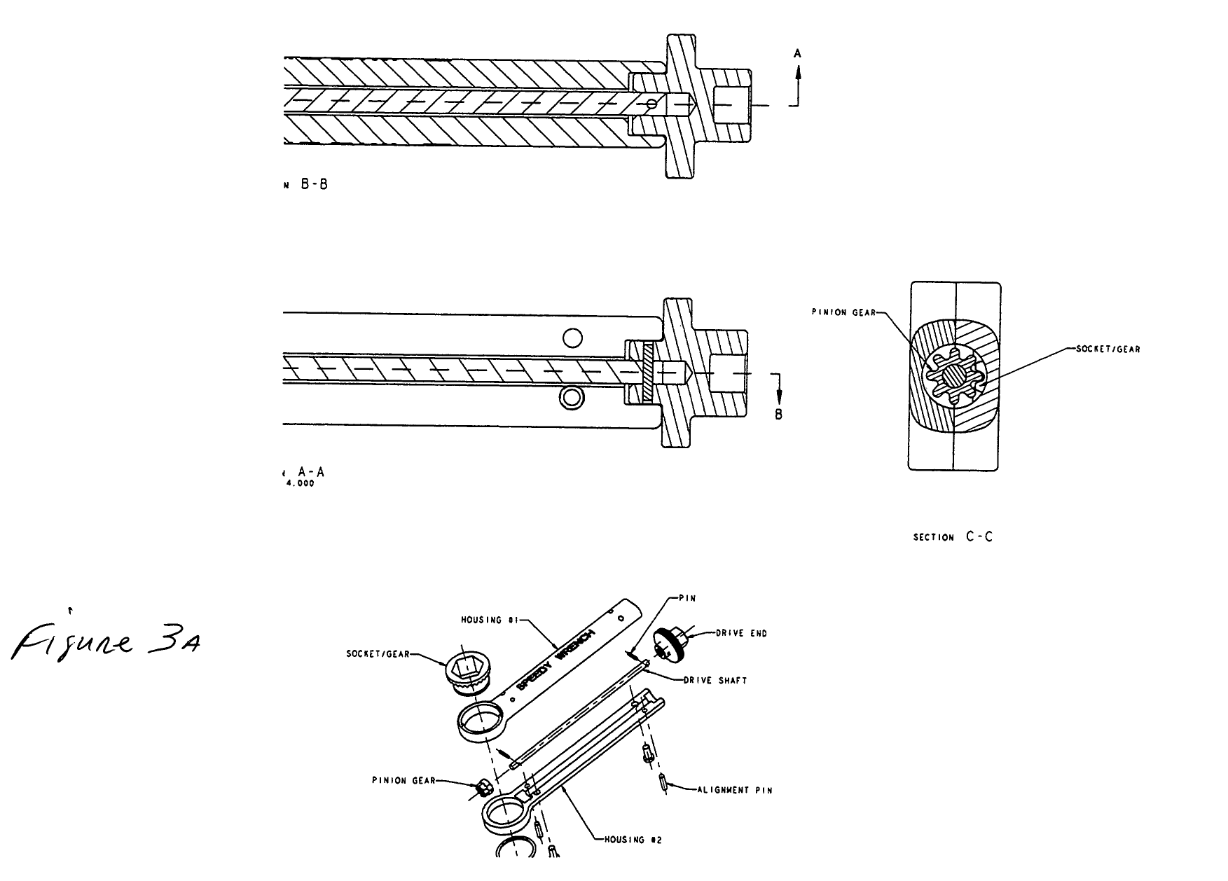

FIG. 3b is an engineered drawing of the dimensions of each component.

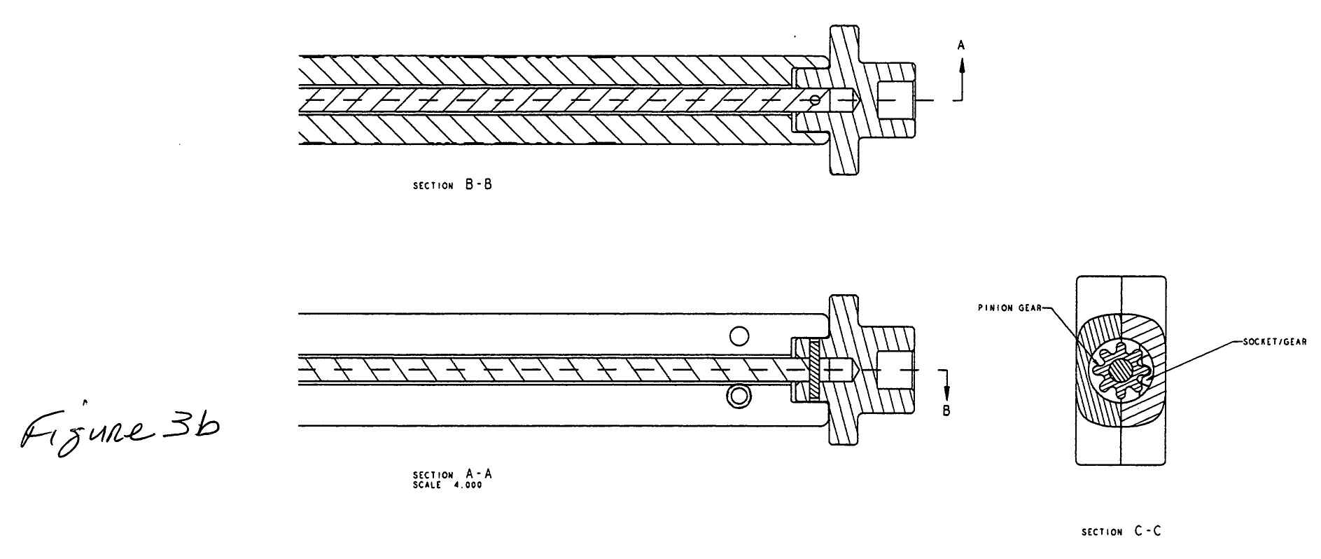

FIG. 4 is an exploded view of the components of the Kwik E Wrench.

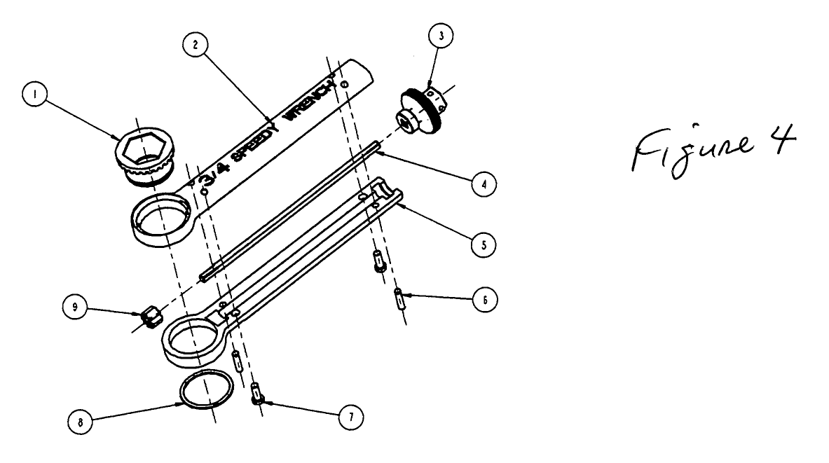

Note: Replace the name Speedy Wrench with Kwik E.

### DETAILED DESCRIPTION OF THE INVENTION

The unique gear design of Kwik E wrench has a drive gear driven by a power source, drill, hand twist, hex end thumb wheel for normal wrench etc. that drives a geared socket of appropriate size for the fastener. All of this is housed in a container much the same size as a normal wrench. The wrench itself does not move, but the geared socket type fitting is turned by a drive gear that rotates the socket to tighten or remove the fastener. Kwik E wrenches come in sizes from ¼ inch all the way up to 1½ inches in 1/16 increments and 6 mm all the way up to 24 mm in size in 2 mm increments. A standard set of SAE Kwik E wrenches or a combination of would be ¼, 5/16, ⅜, ½, 9/16, ⅝, ¾, ⅞, 1 inch(es), and standard metric set or a combination of, would be 6, 8, 10, 12, 14, 15, 17, 19, 21 and 24 mm(s).

1. The Kwik E wrench design is unique in the sense that there are not other wrenches on the market that have a direct gear drive of a geared socket all housed in a container nearly the same size at a normal wrench of that size
There are ratchet drives, but none that are a direct drive of a socket in one container. The design of Kwik E wrench(es) allows usage in confined areas where normal wrenches are limited in movement.
I claim that the gear driven socket driven with a drive gear and shaft is unique and no other wrench like it exists. This gear driven socket and drive gear and shaft is all housed in one housing.
This allows the socket to be rotated by either hand, another wrench or a power driver, ie electric screwdriver or drill in order to tighten or loosen fasteners, (nuts).
